(19) United States
(12) Patent Application Publication
(10) Pub. No.: US 2011/0113910 A1
(43) Pub. Date: May 19, 2011

(54) PORTABLE ELECTRIC GENERATOR

(75) Inventor: Sung-Sub Lee, Gyeonggi-do (KR)

(73) Assignee: SEOBY ELECTRONICS CO. LTD., Anyang-si, Gyeonggi-do (KR)

(21) Appl. No.: 12/279,741

(22) PCT Filed: Jan. 24, 2007
(86) PCT No.: PCT/KR2007/000424

§ 371 Date: Jun. 7, 2010

(30) Foreign Application Priority Data
Mar. 6, 2006 (KR) 10-2006-0020962

(51) Int. Cl. F16H 3/10

(52) U.S. Cl. 74/333

(57) ABSTRACT

A portable electric generator that can be applied to a portable electronic device is provided. The portable electric generator includes a case defining a receiving space, a wheel member rotatably coupled to the case, a driving gear coupled to the wheel member or a shaft of the wheel member, a first one-way rotational gear rotating by a torque transmitted from the driving gear, a second one-way rotational gear rotating by the torque transmitted from the driving gear, a direction change gear rotating by a torque from the second one-way rotational gear, a power transmission gear receiving a torque of the first one-way rotational gear and a torque of the direction change gear, and a generator unit for generating electricity by receiving a torque from the power transmission gear.

### CROSS-REFERENCE TO RELATED APPLICATION

This application claims priority to and the benefit of Korean Patent Application No. 10-2006-0020962 filed in the Korean Intellectual Property Office on Mar. 5, 2006, the entire contents of which are incorporated herein by reference.

### BACKGROUND OF THE INVENTION

(a) Field of the Invention

The present invention relates to a portable electric generator that can be applied to portable electronic appliances such as a remote controller, a mobile device, and the like. More particularly, the present invention relates to a portable electric generator that can effectively generate electricity while uniformly maintaining a voltage.

(b) Description of the Related Art

Generally, a portable electric generator is used for generating a relatively small amount of electricity for portable electronic devices or small electronic devices. The portable electric generator includes an electric generating unit and components for transmitting torque to the electric generating unit. The portable electric generator is configured to manually generate electricity and store the same. For example, the electricity is generated by rotating a rotor of a generator unit by manually rotating a lever, and the electricity is stored in a battery.

Such a conventional portable electric generator has a disadvantage in that it is troublesome to manually rotate the lever. In addition, in order to effectively obtain a predetermined amount of electricity, the generator unit must rotate continuously in a predetermined direction. However, since the conventional portable electric generator cannot sufficiently realize this condition, the electricity generation efficiency is deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an electric generator having advantages of effectively generating electricity by continuously rotating a generator unit with less effort.

According to an exemplary embodiment of the present invention, a portable electric generator includes a case defining a receiving space, a wheel member rotatably coupled to the case, a driving gear coupled to the wheel member or a shaft of the wheel member, a first one-way rotational gear rotating by a torque transmitted from the driving gear, a second one-way rotational gear rotating by the torque transmitted from the driving gear, a direction change gear rotating by a torque from the second one-way rotational gear, a power transmission gear receiving a torque from the first one-way rotational gear and a torque of the direction change gear, and a generator unit for generating electricity by receiving a torque from the power transmission gear.

The portable electric generator may further include an additional power transmission gear that is coupled to the driving gear coupled to the shaft of the wheel member to transmit a torque to the first and second one-way rotational gears.

The first and second one-way rotational gears may be disposed such that a direction of the torque transmitted by the first one-way gear is opposite to a direction of the torque transmitted by the second one-way gear.

The portable electric generator may further include a generator shaft gear that is coupled to the generator unit to receive the torque from the power transmission gear.

Each of the first and second one-way rotational gears includes:

an input gear unit receiving a torque from the wheel member;

a rotation limit member fixed on a shaft of the input gear and provided with a plurality of grooves;

a plurality of rolling members disposed in the respective grooves of the rotation limit member; and

an output gear unit enclosing the rotation limit member and the rolling members and provided at an external circumference with gear teeth.

The grooves of the rotation limit member may be formed facing an inner circumference of the output gear unit, and a distance between each of the grooves and the inner circumference of the output gear unit is gradually reduced in one direction.

The case may be a case of a portable electronic device.

The portable electric generator may be disposed in a portable electronic device.

The wheel member may partly protrude out of the case.

The generator unit may be connected to a battery storing electric energy generated by the generator unit.

### BRIEF DESCRIPTION OF THE DRAWINGS

FIG. 1 is a perspective view of a portable electric generator according to an exemplary embodiment of the present invention.

FIG. 2 is a perspective view illustrating an internal structure of the portable electric generator of FIG. 1.

FIG. 3 is a perspective view of a one-way rotational gear of the portable electric generator of FIGS. 1 and 2.

FIG. 4 is an exploded perspective view of the one-way rotational gear of FIG. 3.

FIG. 5 is a view of a major part of the one-way rotational gear of FIG. 3.

FIG. 6 is a view illustrating an operation of the portable electric generator of FIGS. 1 and 2.

FIG. 7 is a view similar to FIG. 6, illustrating another power transmission process.

FIG. 8 is a graph illustrating an effect of the portable electric generator according to the exemplar embodiment of the present invention.

FIG. 9 is a view illustrating an example where the portable electric generator of FIG. 1 is applied to a portable electronic device.

FIG. 10 is a view illustrating a portable electric generator according to another exemplary embodiment of the present invention.

FIG. 11 a view illustrating a portable electric generator according to another exemplary embodiment of the present invention.

### DETAILED DESCRIPTION OF THE EMBODIMENTS

Exemplary embodiments of the present invention will now be described in more detail with reference to the accompanying drawings.

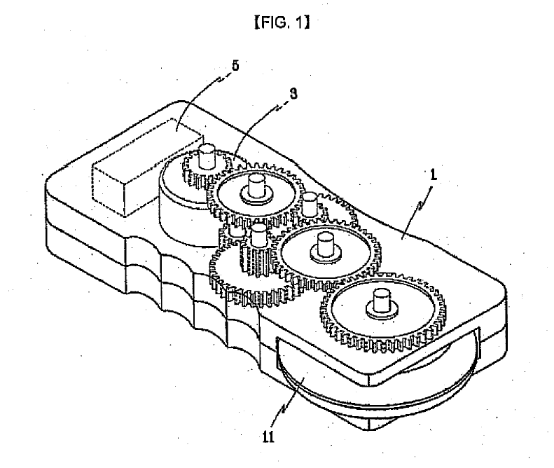

FIG. 1 is a perspective view of a portable electric generator according to an exemplary embodiment of the present invention. Referring to FIG. 1, a portable electric generator includes a case 1 defining a receiving space, an electric generating assembly 3 disposed in the case 1, and a battery 5 that may be disposed in the case 1 to store electricity generated by the electric generating assembly 3.

Although the battery 5 is disposed in the case 1, the present invention is not limited to this case. That is, the battery 5 may be disposed outside of the case as long as it can store the electricity generated by the electric generating assembly 3. In addition, the battery 5 is not limited to a specific structure. That is, the battery 5 may be formed in any structure as long as it can store the electricity generated by the electric generating assembly 3.

The electric generating assembly 3 includes a case 1, a wheel member 11 rotatably coupled to an inner circumference of the case 1, a driving gear 13 disposed on a shaft of the wheel member 11, a first power transmission gear 15 receiving torque from the driving gear 13, first and second one-way rotational gears 17 and 19, a second power transmission gear 21 receiving the torque from the first one-way rotational gear 17, a generator shaft gear 23 receiving the torque from the second power transmission gear 21, a generator unit 25 for generating electric energy in accordance with the rotation of the generator shaft gear 23, and a direction change gear 27 for transmitting the torque of the second one-way rotational gear 19 to the second power transmission gear 21.

The wheel member 11 may partly protrude out of the case 1. The wheel member 11 is coupled to the case 1. That is, a part of the wheel member 11 is disposed at an outside of the case 1. Accordingly, the user rotates the wheel member 11 by pushing or pulling the wheel member 11 in a state where he/she grasps the case 1 and the wheel member 11 contacts a floor, The driving gear 13 may be coupled to a shaft to which the wheel member 11 is coupled. Therefore, the driving gear 13 rotates as the wheel member 11 rotates. In an exemplary embodiment of the present invention, the driving gear 13 is coupled to the shaft of the wheel member 11 to rotate together with the wheel member 11. However, the present invention is not limited to this configuration. For example, the driving gear 13 may be coupled to the wheel member 11 by a fastener such as a screw. The first power transmission gear 15 may be formed on a conventional gear structure and rotatably coupled in the case 1. The first power transmission gear 15 is engaged with the driving gear 13 to receive the torque of the driving gear 13. The first one-way rotational gear 17 is rotatably coupled in the case 1 such that it receives the torque of the first power transmission gear 15 and transmits the torque to the second power transmission gear 21. The first one-way rotational gear 17 is configured to transmit torque of the first power transmission gear 15 to the second power transmission gear 21 in only one direction. The second power transmission gear 21 transmits the torque to the generator shaft gear 23 to rotate a rotor (not shown) of the generator unit 25, thereby generating electricity.

The second one-way rotational gear 19 is coupled in the case 1 and engaged with the first power transmission gear 15 to transmit the torque to the direction change gear 27. The direction change gear 27 is configured to transmit the torque to the generator shaft gear 23 via the second power transmission gear 21. The first and second one-way rotational gears 17 and 19 may be configured such that the torque transmitted by the first one-way rotational gear 17 is opposite to that of the second one-way rotational gear 19.

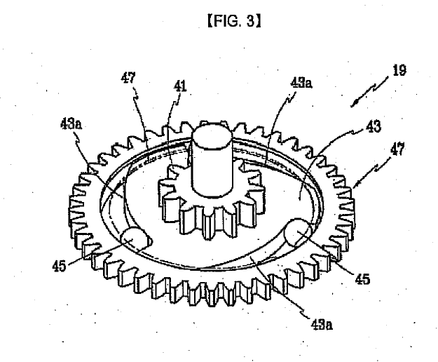

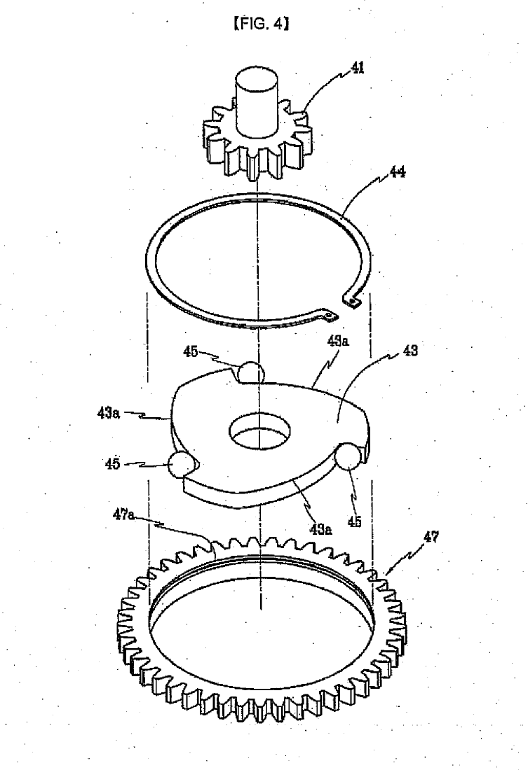

Since the structures of the first and second one-way rotational gears 17 and 19 are identical to each other, only the structure of the second one-way rotational gear 19 will be described with reference to FIGS. 3, 4, and 5 by way of example.

The second one-way rotational gear 19 includes an input gear unit 41 that is engaged with the first power transmission gear 15 to receive the torque, a rotation limit member 43 that is fixed on a shaft on which the input gear unit 41 is fixed and provided with a plurality of grooves 43a, a plurality of rolling members 45 disposed in the grooves 43a of the rotation limit member 43, and an output gear unit 47 that is disposed to enclose the rotation limit member 43 10 and the rolling members 45 and provided at an external circumference with gear teeth. The second one-way rotational gear 19 may further include a snap ring 44 for maintaining the disposed position of the rotation limit member 43 and the rolling members 45. The snap ring 44 is fitted in a snap ring groove 47a provided on an inner circumference of the output gear unit 47 to maintain the rotation limit member 43 and the rolling members 45 in a predetermined location.

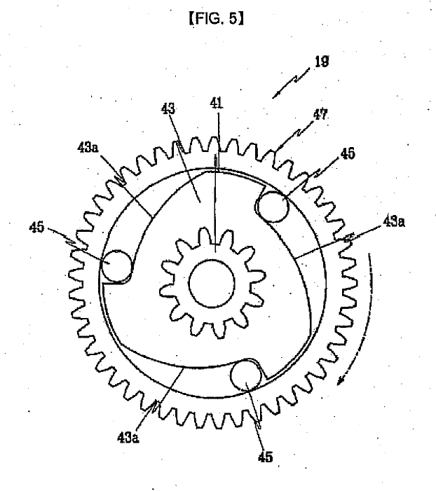

The rotation limit member 43 is coupled to a shaft of the input gear unit 41 to rotate together with the input gear unit 41, and is provided at an outer circumference with a plurality of grooves 43a. The grooves 43a formed on the rotation limit member 43 are formed to face an inner circumference 47a of the output gear unit 47. A distance between each of the grooves 43a and the inner circumference 47a of the output gear unit 47 is gradually reduced in one direction. That is, the rolling members 45 formed in a spherical or cylindrical shape are inserted in the respective grooves 43a formed on the rotational limit member 43, and an external circumferential surface of each of the grooves 43a is smaller than a diameter of the rolling member 45. As shown in FIG. 5, when the rotation limit member 43 rotates clockwise (indicated by arrow), the rolling members 45 do not affect the rotation and thus the rotation limit member 43 idles. Therefore, the torque of the input gear unit 41 is not transmitted to the output gear unit 47. When the rotation limit member 43 rotates counterclockwise, the roller members 45 inserted in the respective grooves 43a closely contact the inner surface of the output gear unit 47 and thus the torque of the input gear unit 41 is transmitted to the output gear unit 47.

The torque transmission structure between the input gear unit 41 and the output gear unit 47 is not limited to the above structure. Any structure that can transmit torque of the input gear unit 41 in only one direction to the output gear unit 47 will also be applicable.

Although only the second one-way rotational gear 19 is illustrated and described for convenience, the first one-way rotational gear 17 may have the same structure as the second one-way rotational gear 19, However, the first one-way rotation gear 19 is structured to rotate in a direction opposite to a direction in which the second one-way rotational gear 19 rotates.

The direction change gear 27 is provided to allow a rotational direction of the second power transmission gear 21 by the torque of the second one-way rotational gear 19 to be same as a rotational direction of the second power transmission gear 21 by the torque of the first one-way rotational gear 17. The torque transmitted to the second power transmission gear 21 is transmitted to the generator shaft gear 23 to rotate the generator unit 25.

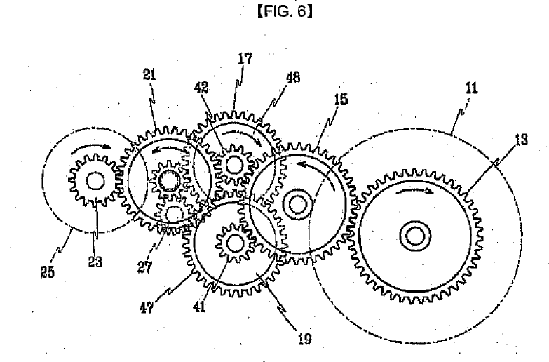

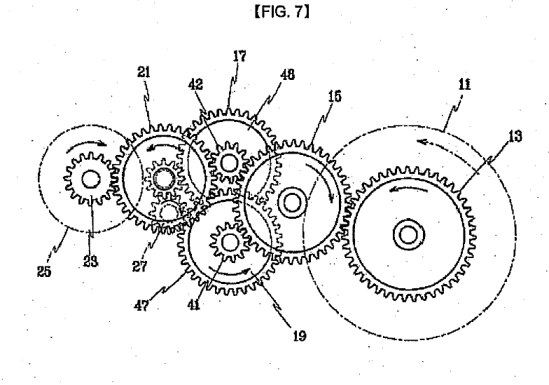

The following will describe an operation of the above-described portable electric generator of the exemplary embodiment of the present invention with reference to FIGS. 6 and 7.

When the user rotates the wheel member 11 clockwise by pushing the wheel member 11 contacting the floor, the driving gear 13 rotates together with the wheel member 11. Then, the first power transmission member 15 receives the torque of the driving gear 13 to rotate counterclockwise, by which the first one-way rotational gear 17 rotates clockwise. The first one-way rotational gear 17 transmits the torque to the second power transmission gear 21 as the first power transmission member 15 integrally rotates together with the input gear unit 21, the rotation limit member 43, and the output gear unit 47. At this point, since the input gear unit 41 freely rotates with respect to the output gear unit 47, the torque is not transmitted through the second one-way rotational gear 19. Accordingly, the torque transmitted to the second power transmission gear 21 rotates the generator shaft gear 23 clockwise, thereby operating the generator unit.

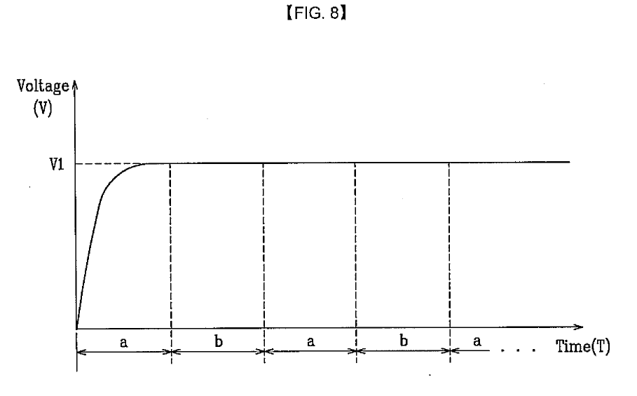

As shown in FIG. 7, when the user rotates the wheel member 11 counterclockwise by pulling the wheel member 11 contacting the floor, the driving gear 13 rotates counterclockwise together with the wheel member. The first power transmission gear 15 receives the torque of the driving gear 13 to rotate clockwise and the second one-way rotational gear 19 rotates counterclockwise. At this point, since the first one-way rotational gear 17 freely rotates, no torque is transmitted through the first one-way rotational gear 17. As the direction change gear 27 transmits torque from the the second one-way rotational gear 19 to the second power transmission gear 21, the second power transmission 21 rotates counterclockwise. The generator shaft gear 23 rotates clockwise by the second power transmission gear 21, thereby operating the generator unit. Accordingly, regardless of the rotational direction of the wheel member 11, the generator shaft gear 23 always rotates in the same direction and thus a graph illustrating a voltage with respect to time can be obtained as shown in FIG. 8. That is, since the generator shaft gear 23 continuously rotates, a uniform voltage (V1 of FIG. 8) can be obtained during the rotation of the generator shaft gear 23. When it is assumed that “a” in FIG. 8 is a case where the wheel member 11 rotates clockwise, “b” in FIG. 8 is a case where the wheel member 11 rotates counterclockwise. That is, the uniform voltage can be obtained regardless of the rotational direction of the wheel member 11.

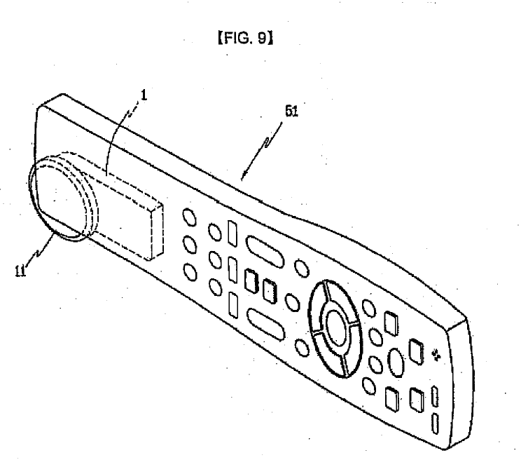

FIG. 9 is a view illustrating an example where the above-described portable electric generator is applied to a remote controller. The portable electric generator is installed in a remote controller 51. Although it is exemplified that the portable electric generator is installed in the remote controller 51, the present invention is not limited to this example. That is, the portable electric generator of the present invention can be also applied to a mobile communication device and other portable electronic devices so that the devices can be used without changing or charging the battery.

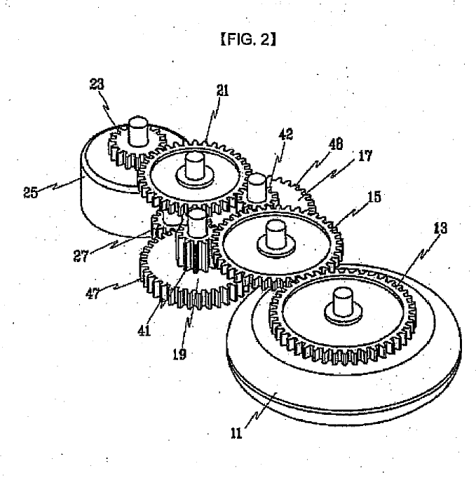

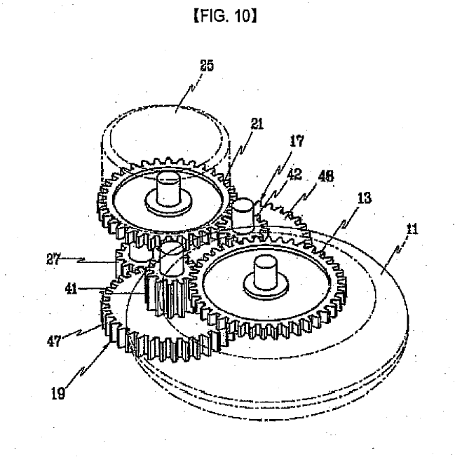

FIG. 10 is a view illustrating a portable electric generator according to another exemplary embodiment of the present invention. Only different parts from the foregoing exemplary embodiment will be described hereinafter. In the exemplary embodiment of FIG. 10, first and second one-way rotational gears 17 and 19 are directly engaged with the driving gear 13 to transmit torque. That is, if necessary, the first power transmission gear 15 of the foregoing exemplary embodiment of FIGS. 1 through 7 may be omitted and the first and second one-way rotational gears 17 and 19 may be directly engaged with the driving gear 13 so that the torque can be directly transmitted to the first and second one-way rotational gears 17 and 19 from the driving gear 13. As shown in FIG. 10, a second power transmission gear 21 is coupled to a generator shaft to operate a generator unit. The portable is electric generator of this exemplary embodiment has a simpler structure than that of the portable electric generator of the foregoing exemplary embodiment of FIGS. 1 through 7, but provides the same effects.

Meanwhile, in this embodiment, the case 1 of the foregoing embodiment may be replaced with a case of a portable electronic device to which the portable electric generator of this embodiment is applied. That is, the portable electric generator of the present invention can be used as an independent electricity generator or directly built in the portable electronic device to be used as an electricity generator of the portable device.

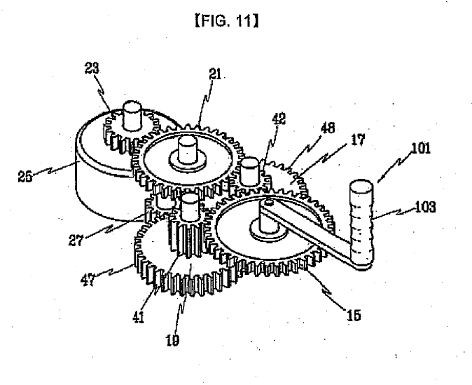

FIG. 11 is a view illustrating a portable electric generator according to another exemplary embodiment of the present invention. Only different parts from the foregoing exemplary embodiments will be described hereinafter.

In the foregoing exemplary embodiments, the generation of electricity is realized by pushing or pulling the wheel member 11 contacting the floor. However, in this exemplary embodiment, the wheel member 11 and the driving gear 13 are omitted and a rotational member 103 with a crank handle 101 is provided to extend from a rotational shaft of a power transmission gear 15. That is, by rotating the crank handle 101 in a direction (clockwise or counterclockwise), torque is generated and this torque is transmitted to the shaft of the generator unit 25 through the power transmission path described in the foregoing embodiment, thereby generating electricity. In this embodiment, the generator unit 25 generates the electricity while rotating in a predetermined direction regardless of the rotational direction of the crank handle 101. As described above, the present invention can be variously embodied.

According to the present invention, since the user can conveniently use the portable electric generator and continuously rotate the generator unit in only one direction with less effort, the electricity generation efficiency can be maximized.

### INDUSTRIAL APPLICABILITY

The electric generator of the present invention may be used as an independent portable electric generator or built in a portable electronic device as an electric generator of the portable electronic device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A portable electric generator comprising;
a case defining a receiving space;
a wheel member rotatably coupled to the case;
a driving gear coupled to the wheel member or a shaft of the wheel member;
a first one-way rotational gear rotating by a torque transmitted from the driving gear;
a second one-way rotational gear rotating by the torque transmitted from the driving gear;
a direction change gear rotating by a torque from the second one-way rotational gear;
a power transmission gear receiving a torque of the first one-way rotational gear and a torque of the direction change gear; and
a generator unit for generating electricity by receiving a torque from the power transmission gear.

2. The portable electric generator of claim 1, further comprising an additional power transmission gear that is coupled to the driving gear coupled to the shaft of the wheel member to transmit a torque to the first and second one-way rotational gears.

3. The portable electric generator of claim 1, wherein the first and second one-way rotational gears are disposed such that a direction of the torque transmitted by the first one-way gear is opposite to a direction of the torque transmitted by the second one-way gear.

4. The portable electric generator of claim 1, further comprising a generator shaft gear that is coupled to the generator unit to receive the torque from the power transmission gear.

5. The portable electric generator of claim 1, wherein each of the first and second one-way rotational gears includes:
an input gear unit receiving a torque from the wheel member;
a rotation limit member fixed on a shaft of the input gear and provided with a plurality of grooves;
a plurality of rolling members disposed in the respective grooves of the rotation limit member; and
an output gear unit enclosing the rotation limit member and the rolling members and provided at an external circumference with gear teeth.

6. The portable electric generator of claim 5, wherein the grooves of the rotation limit member are formed facing an inner circumference of the output gear unit, and a distance between each of the grooves and the inner circumference of the output gear unit is gradually reduced in one direction.

7. The portable electric generator of claim 1, wherein the case is a case of a portable electronic device.

8. The portable electric generator of claim 1, which is disposed in a portable electronic device.

9. The portable electric generator of claim 1, wherein the wheel member partly protrudes out of the case.

10. The portable electric generator of claim 1, wherein the generator unit is connected to a battery storing electric energy generated by the generator unit.

11. The portable electric generator of claim 5, wherein the rolling member is spherical.

12. The portable electric generator of claim 5, wherein the rolling member is cylindrical.

13. A portable electric generator comprising:
a case defining a receiving space;
a first power transmission gear rotatably disposed in the case;
a rotational member coupled to a shaft of the power transmission gear;
a first one-way rotational gear rotating by a torque transmitted from the first power transmission gear;
a second one-way rotational gear rotating by the torque transmitted from the first power transmission gear;
a direction change gear rotating by a torque from the second one-way rotational gear;
a power transmission gear receiving a torque of the first one-way rotational gear and a torque of the direction change gear; and
a generator unit for generating electricity by receiving a torque from the power transmission gear.

14. The portable electric generator of claim 13, wherein the first and second one-way rotational gears are disposed such that a direction of the torque transmitted by the first one-way gear is opposite to a direction of the torque transmitted by the second one-way gear.

15. The portable electric generator of claim 13, wherein the case is a case of a portable electronic device.

16. The portable electric generator of claim 13, which is disposed in a portable electronic device.

17. The portable electric generator of claim 13, wherein the generator unit is connected to a battery storing electric energy generated by the generator unit.
